(19) United States
(12) Patent Application Publication
(10) Pub. No.: US 2007/0041791 A1
(43) Pub. Date: Feb. 22, 2007

(54) Method of treating municipal solid waste offshore: alternative to incineration and landfill

(76) Inventor: Victor Corpus, Manila (PH)

Correspondence Address: Victor N. Corpus, 2149 A. Mabini Street, Malate, Manila, 1004, PH

(21) Appl. No.: 11/205,330

(22) Filed: Aug. 17, 2005

(51) Int. Cl. B09B 1/00

(52) U.S. Cl. 405/129.1

(57) ABSTRACT

A method of treating municipal solid waste by first segregating the recyclables, the non-recyclables, and the biodegradable waste. Recyclables are sold to recycling firms. Non-recyclables are sealed airtight in barges that serve as platforms for vermi-composting and food production offshore. The biodegradable waste is brought to an offshore facility where it is fed to earthworms, converting organic waste into castings and protein meal. Food production is conducted in tandem with vermi-composting to complete the recycling process. Earthworms are fed to freshwater fish. Earthworm protein serves as feed ingredient for livestock. Castings serve as substrate for organic crops in greenhouses. Waste from livestock serves as activator for composting organic municipal waste and input to biogas digesters. Freshwater fish serves as feed for saltwater fish in cages in-between the barges. Thus, the recycling cycle turns full circle with: zero waste, where the municipal waste is completely disposed of without polluting the environment.

### CROSS-REFERENCE TO RELATED APPLICATIONS

This application claims the benefit of Philippine Pending Patent Application No. 1-2005-000336 filed on Jul. 6, 2005 by the present inventor.

### BACKGROUND OF THE INVENTION

### Field of Invention

The present invention relates to the treatment and disposal of municipal solid wastes, and more specifically to the treatment and disposal of municipal solid wastes offshore.

### BACKGROUND OF THE INVENTION

There are two principal methods of municipal solid waste disposal used in the world today: incineration and sanitary landfill. These popular methods of disposing and managing waste, however, come with serious environmental hazards.

Incinerators bum municipal waste to convert the waste into energy. The big problem with incinerators is that they also convert waste into hazardous air emissions and toxic ashes. In burning waste, Incinerators spew carcinogenic and toxic elements from their smoke stacks; including dioxin compounds, lead, mercury, cadmium, nitrous oxide, arsenic, fluorides, and particulates that can be inhaled and lodge permanently in the lungs. Dioxin was identified by the World Health Organization as a known human carcinogen in 1997. Dioxin has been found to rapidly build up in the food chain. From Incinerator smoke stacks, tiny dioxin particles attach to dust particles and travel long distances. It lands on grass and animal feed wherein it bio-accumulates as it moves up in the food chain. When people eat or drink the contaminated animal product, the dioxin in the animal body is transferred to humans. Dioxin is known to contaminate human breast milk; and these, in turn, are transferred to their babies. It is also linked to birth defects, immune system dysfunction, hormonal imbalances, male infertility and other health problems. People around incinerators can be affected by dioxin either indirectly through the food chain; or directly, through inhalation of polluted air or drinking water contaminated by this hazardous pollutant.

Some incinerators may be equipped with expensive filters in their smoke stacks (a luxury which most developing countries cannot afford or care to install), but despite such precautions, air pollution from incinerators remain a serious problem. Filtering the hazardous emissions only makes the residual ashes even more toxic. About 10-30% of the burned waste materials are converted into ash. The problem again is where to dispose of these toxic residues laden with heavy metals, dioxins and: furans. Disposing them in landfills only endanger underground water reservoirs and aquifers even more.

Another serious issue raised on the use of incinerators for waste disposal is the permanent loss of resources that can be recovered from garbage. Aside from non-biodegradable materials that can be recovered for reuse or recycling, the biodegradable portion of the waste can be turned into compost and plowed back into the ecosystem. Incinerators burn them all, and in the process, create more environmental problems than they intended to solve.

Sanitary landfills, on the other hand, bury the mixed municipal waste in the ground. The most serious drawback of this method of waste disposal is the contamination of water ways and aquifers. There are more than 2,000 landfills in the U.S. today, and more than 75% of these have no lining to protect the nearby aquifers from being contaminated by the leachates emanating from landfills. Leachates are the liquid mixtures produced by rainwater passing through a landfill. When rainwater percolates through the waste material, traces of lead, mercury, cadmium and other toxic contaminants are mixed with the liquid. Leachates from landfills that seep into aquifers or find their way into waterways pollute and render water supplies unfit for human use. To realize the gravity of this problem, let us take the case of the Fresh Kills Landfill in New York, considered as the largest manmade object in the world covering some 3,000 acres and about 200 feet high. This famous landfill leaks an estimated 1 million gallons of leachate into the surrounding water table every day (Miller).

Although about 70% of the earth's surface is covered with water, only less than 1% of water in the planet is available for sustaining life; and most of these can be found in underground water reservoirs or aquifers. About 50% of Americans use groundwater for drinking while almost all who live in the rural areas of the U.S. depend on groundwater. Water being the source of life and the most important natural resource is seriously threatened by contamination coming from hundreds of landfill sites dotting the U.S.

Although legislation was passed in the U.S. requiring landfills to install linings to prevent leachates from landfills to contaminate aquifers in 1992, such a solution will only delay eventual pollution of underground water. All linings have finite existence. They will eventually degrade through the years, and in the end the pestering problem remains.

Another problem with sanitary landfills is the hazardous gases they emit to the atmosphere. The landfill Gas Testing Program of the State of California has demonstrated that landfill gases typically contain toxic volatile organic compounds (VOCs) regardless of the type of waste they are designated to accept and that off-site migration of landfill gas is a fairly common occurrence (Hodgson et al. 1992). Landfills produce methane, an explosive gas which, when released to the atmosphere, is one of the worst contributors to global warming.

Landfills are also rejected by most communities because of the attendant foul odor that usually goes with its operation. And land for use in landfills is becoming more difficult to find because of landfill special requirements. Most landfills in the East Coast of the U.S. are due to close in 5 to 10 years. By then, no community in the area would want the waste dumped in their “backyard” to be another Staten Island. The big problem is where to dump the waste.

It is also known in the art to use offshore biogas digesters or septic tanks. This process involves depositing the mixed municipal waste into barges. As the barges are filled up, they are sealed and brought offshore. The waste is allowed to decompose under anaerobic conditions for eighteen (18) months. The barges are envisioned to be equipped with facilities to collect the methane gas produced by the decaying organic matter in the encased waste materials. In short, the barges serve as floating biogas digesters or “septic tanks”. After 18 months, the barges will be reopened and “mined” for whatever can be recovered and recycled.

The aforesaid process has been observed to have some drawbacks in that the collected waste is merely dumped into barges without prior segregation, thus making recycling difficult. The waste is dumped into the barge still wrapped inside plastic waste bags. This precludes the entry of oxygen needed to decompose organic matter. Still wrapped in plastic inside the sealed barges, the methane will not be able to escape from the plastic containers, precluding the efficient collection and use of the methane gas produced in anaerobic decomposition. Instead of being collected, methane gas, CO₂ and hydrogen sulfide will accumulate inside the waste bags, such that opening the barges poses the risk of explosion coming from the gases trapped in the waste bags. An explosion in one bag can trigger the explosion of the rest, since all of the bags contain trapped methane in them.

Another problem of the said method is that the process involves anaerobic decomposition. Studies have shown that anaerobic decomposition, i.e., decomposition in the absence or lack of oxygen, is inefficient and ineffective in decomposing organic waste. In some reported cases in the United States, bananas, hotdogs, chicken with bones, etc. that were thrown in landfills more than a decade ago and underwent the process of anaerobic decomposition remained intact to this day.

### SUMMARY OF THE INVENTION

Accordingly, several objects and advantages of this invention are as follows: a) solve a previously insoluble environmental problem by providing a safe place for disposing and recycling municipal waste; b) solve a long-felt public need for a waste disposal method without the attendant environmental hazards of dioxins, furans, heavy metals, explosive gases, toxic ashes and leachates polluting air, land and water resources which are attendant to incinerators and sanitary landfills; c) reduce waste volume by recovering and reusing recyclables; d) recycle biodegradable waste back into the ecosystem; e) integrate waste recycling with food production offshore for the very first time; and f dispose non-recyclable waste safely that leads to two important, significant, and unexpected new results, i.e., food produced in a unique way and a never-ending, ever-expanding, valuable floating real estate.

The method of treating municipal solid waste envisioned in this invention starts with segregation of the mixed municipal solid waste into recyclable, non-recyclable, and biodegradable. The segregation process can be done inland or offshore.

The recyclable items are sorted out and sold direct to recycling firms.

The non-recyclable waste are compacted and sealed in flat-top floating vessels such as ferro-cement barges that are towed to an offshore recycling and food production facility where they serve as platforms for vermi-composting and food production, with a double purpose of also serving as breakwater for the entire offshore complex. In the latter phase of operation, excess waste depository barges start forming a constantly expanding floating real estate. This floating real estate can be towed to where the value of real estate is most favorable. The latter is one of the significant, valuable, unexpected new results of this invention.

The biodegradable portion of the waste is recycled by means of vermi-composting in combination with food production on the floating vessels used as depositories for non-recyclable waste.

The end result of all these is solving a previously insoluble environmental problem of where to dump the municipal waste. It also solves the long-felt need to address the attendant air, land and water pollution that go with current waste treatment methods. In the process, new, unexpected, valuable results are derived, i.e., food produced in a unique way offshore and a never-ending, ever-expanding, floating real estate.

### BRIEF DESCRIPTION OF THE DRAWINGS

FIG. 1 shows a schematic diagram of an offshore municipal waste treatment process flow chart.

FIG. 1-A shows an input-process-output diagram of the waste treatment process.

FIG. 2 shows a schematic diagram of a pier leading to an offshore segregation facility.

FIG. 3 shows a side view of a portion of an offshore municipal waste treatment facility.

FIG. 3-A shows a perspective view of a vermi-composting barge.

FIG. 3-B shows a perspective view of a food production barge.

FIG. 4 shows the top view of vermi-composting bins on flat-top surface of a vermi-compost barge

FIG. 5 shows a schematic diagram of an offshore municipal waste treatment facility.

FIG. 6 shows a perspective view of an uncovered ferro-cement barge

### DETAILED DESCRIPTION OF THE DRAWINGS

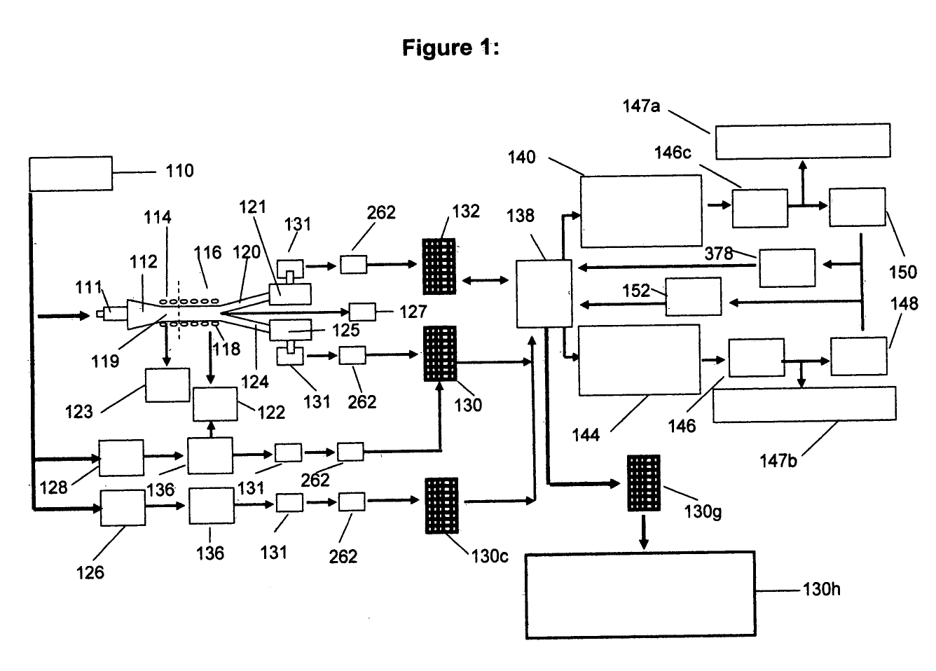

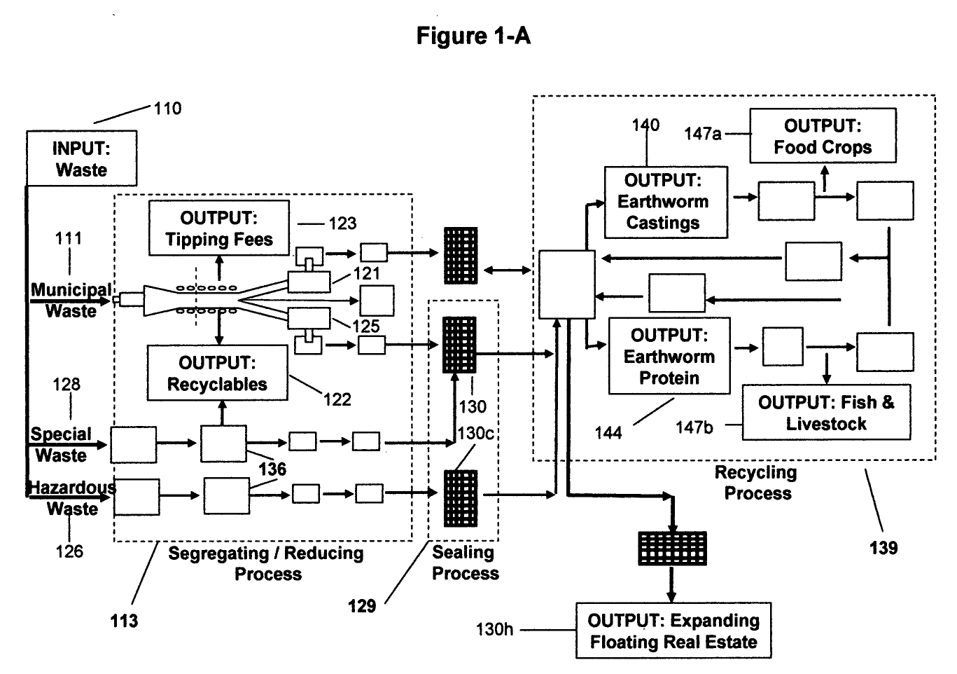

A preferred embodiment of the municipal waste treatment process is illustrated in the schematic diagram shown in FIG. 1. Urban waste 110 comprising of mixed municipal waste 111; special waste 128 such as construction and demolition waste, white goods, tires, and bulky furniture; and hazardous waste 126 are brought separately to the segregation facility. Dump trucks deposit the mixed municipal waste 111 on a tapering ramp 112 where the waste materials are removed from their plastic containers at a debagging section 114. Said waste materials are brought by conveyor belt 119 to a segregation section 116 where sorters 118 in rubber gloves, masks with filters, protective clothing, and using various manual tools segregate the biodegradable 120 from the non-biodegradable and non-recyclable materials 124. Sorters also separate the recyclable materials 122 to be sold to recycling firms. There will be a series of modular tapering rumps 112 leading to conveyor belts 119 with corresponding grinders, shredders, or compactors to accommodate the daily volume of waste as required in a particular area. Tipping fees 123 are preferably collected to defray the operational expenses. Leachates are collected and treated in a leachate pond or barge 127.

The segregated biodegradable materials go to a grinder 121 where the said materials are grinded, seeded with enzyme, lime and zeolite, and loaded by conveyor to transfer bins 131. The filled-up bins, in turn, are covered and loaded by tower crane 262 to a shuttle barge 132 which will bring the waste materials to an offshore municipal waste treatment facility 138.

The non-recyclable materials 124, on the other hand, are reduced by appropriate grinders, shredders, or crushing machines 121, and/or compacted by compactors 125 and also loaded in transfer bins 131. The non-recyclable materials 124 are transferred by tower crane 262, deposited and sealed airtight in flattop floating vessels 130 such as barges preferably made of ferro-cement. It should be appreciated that the floating vessels may also be comprised of either metal or other laminated cementitious composite materials which are sealed airtight when full. The sealed vessels 130 are towed to an offshore waste treatment facility 138 where the sealed barges serve as vermi-composting platforms, food production platforms, breakwater, and as building blocks for a floating real estate.

Special kinds of waste 128 such as white goods (discarded refrigerators, freezers, and the like), bulky furniture, construction and demolition debris, tires, etc. are collected and brought to the segregation facility separately and treated by means of shredding, crushing, grinding or compacting 136 as appropriate; wherein the ferrous and non-ferrous metals as well as other recyclable materials 122 are recovered, while the residual non-recyclables are further reduced by grinding machines or compactors 136 before being deposited and sealed in the depository barges 130.

Hazardous waste 126 are decontaminated, grinded, shredded, crushed or compacted when applicable 136 and deposited in separate ferro-cement barges 130c that will be towed to the offshore facility where they will be kept safe behind a double breakwater.

The biodegradable waste brought by the shuttle barge 132 are unloaded at an offshore waste treatment facility 138 where the materials are piled in concrete bins, composted and fed to earthworms. The waste materials are then converted into earthworm castings 140. In the process of vermi-composting, earthworms are produced that can be harvested, dried and used as earthworm protein meal 144, an important protein ingredient for livestock and fish feed.

The earthworm castings, on the other hand, are mixed with soil and rice hulls to serve as substrate for raising organic products in greenhouses 146c on the top deck of the vermi-compost and food barges resulting in organically-grown crop food output 147a. Part of the output of earthworm castings 140 may be packaged and sold to retailers as soil conditioner. This is one of the important outputs and income sources of the process.

The worm protein meal 144 serve as protein feed ingredient for fish and livestock 146 resulting in livestock food output 147b. Manure waste from livestock, livestock casualties, and waste cuttings from the greenhouses serve as activator 152 for composting of the biodegradable waste and as inputs to biogas digesters 378. Residues from biogas digesters, in turn, are also fed to earthworms. Hence, the recycling process turns full circle resulting in zero waste. Excess depository barges 130g may be connected end-to-end and side-by-side serve as building block in an ever-expanding floating real estate 130h or a form of floating land reclamation offshore. Thus the end result of the whole process is the disappearance of the municipal waste with no concomitant pollution, with food production and valuable floating real estate as unexpected results.

FIG. 1-A shows an Input-Process-Output diagram of the invention. The inputs are urban waste 110 which include municipal solid waste 111; special waste 128, such as white goods, tires, bulky furniture, construction and demolition debris; and some forms of hazardous waste 126, such as hospital waste, electronic waste, etc., with the exception of radioactive waste. The inputs undergo three basic processes: the segregating/reducing process 113; the sealing process 129; and the recycling process 139.

The segregating/reducing process 113 involves the segregation of mixed municipal solid waste into recyclable, non-recyclable, and biodegradable materials, wherein two outputs are derived: recyclable materials 122; and, tipping fees 123. Segregation is combined with reduction of waste by subjecting them to crushing, shredding, grinding, or compacting 121, 125, and 136 as the case may be.

The segregating/reducing process is followed by the sealing process 129, wherein the non-recyclable as well as the hazardous waste are disposed off by sealing the compacted or shredded waste materials airtight in ferrocement barges 130 and 130c respectively. The excess barges containing non-recyclable and non-hazardous waste 130g form part of a constantly expanding and floating real estate 130h—one of the valuable outputs of this method. Alternatively, the non-biodegradable or non-recyclable waste materials that are not hazardous or non-toxic may be grinded and mixed with sand and cement to produce aggregates or hollow blocks for construction materials. This will further reduce the amount and volume of waste that ultimately end up sealed in the barges.

The third and final process is the recycling process 139 wherein the segregated biodegradable waste is recycled by means of a combination of vermi-composting and food production. What comes out of the final process are outputs that include: a) earthworm castings 140; c) organic food crops 147a; d) earthworm protein 144, and, e) fish and livestock 147b.

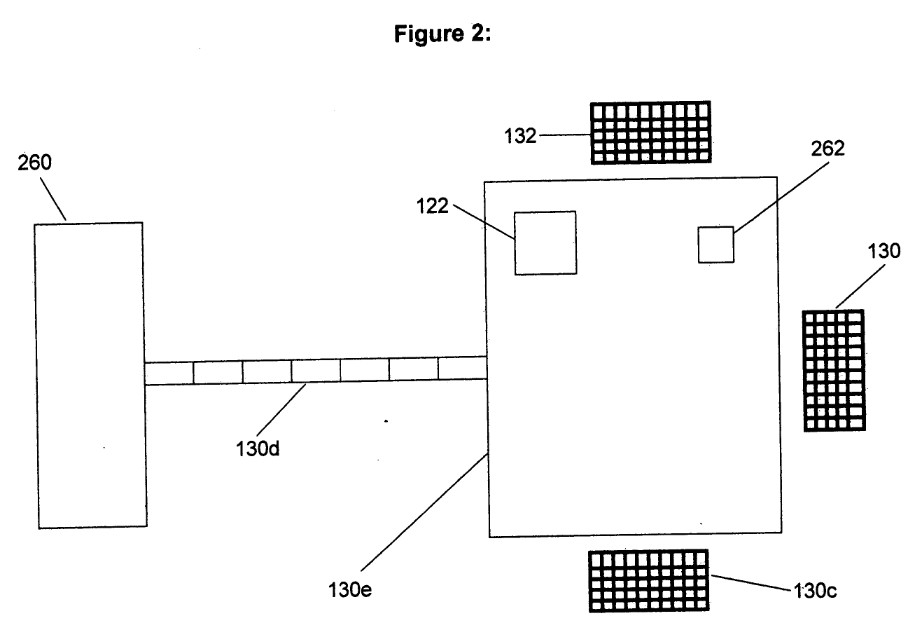

FIG. 2 shows a schematic diagram of a pier leading to an offshore waste segregation facility. Ferro-cement barges are aligned in a single row to form the connecting access road 130d from the pier 260 to an offshore platform serving as an offshore waste segregation facility 130e. The recyclable materials 122 are separated and stored in a warehouse. The segregated biodegradable waste goes to a shuttle barge 132 which will bring the material to an offshore vermi-composting facility. The non-recyclable waste is deposited and sealed in a depository barge 130. The hazardous waste is sealed in a separate barge for hazardous waste 130c. The transfer of the segregated waste materials to their respective barges is facilitated by the use of tower cranes 262.

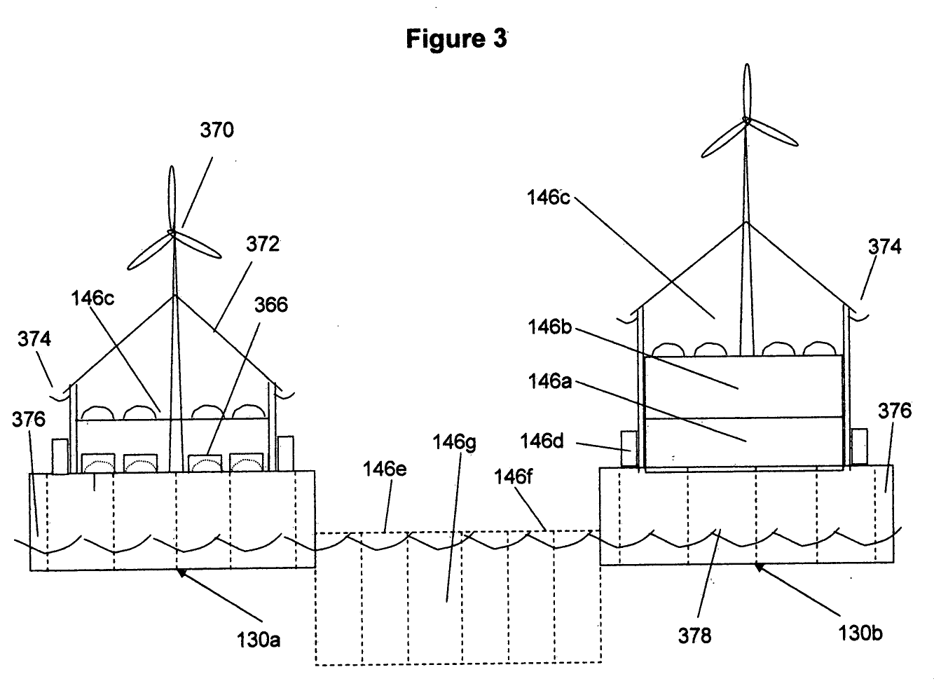

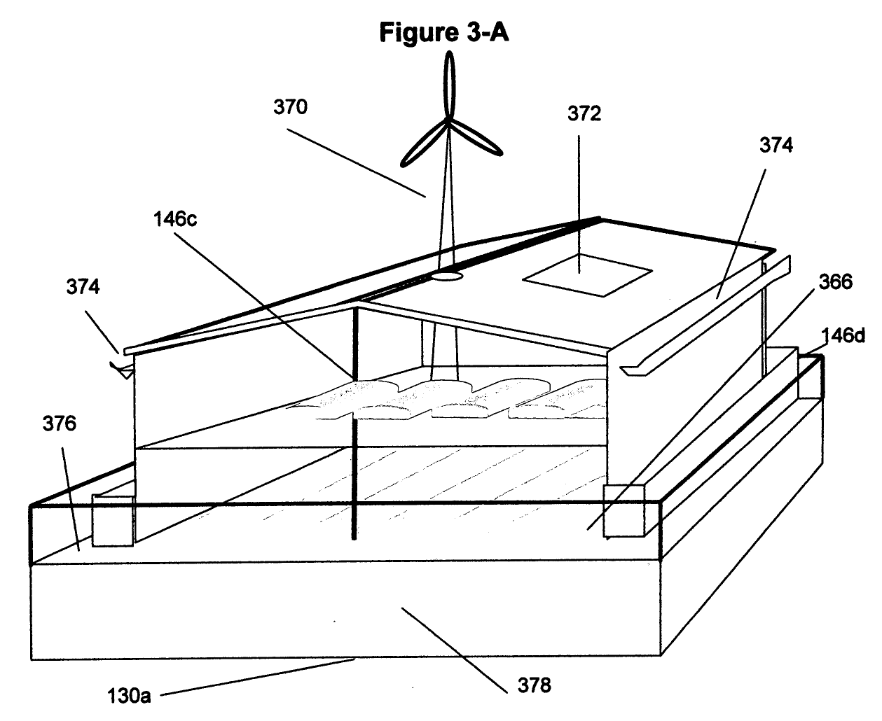

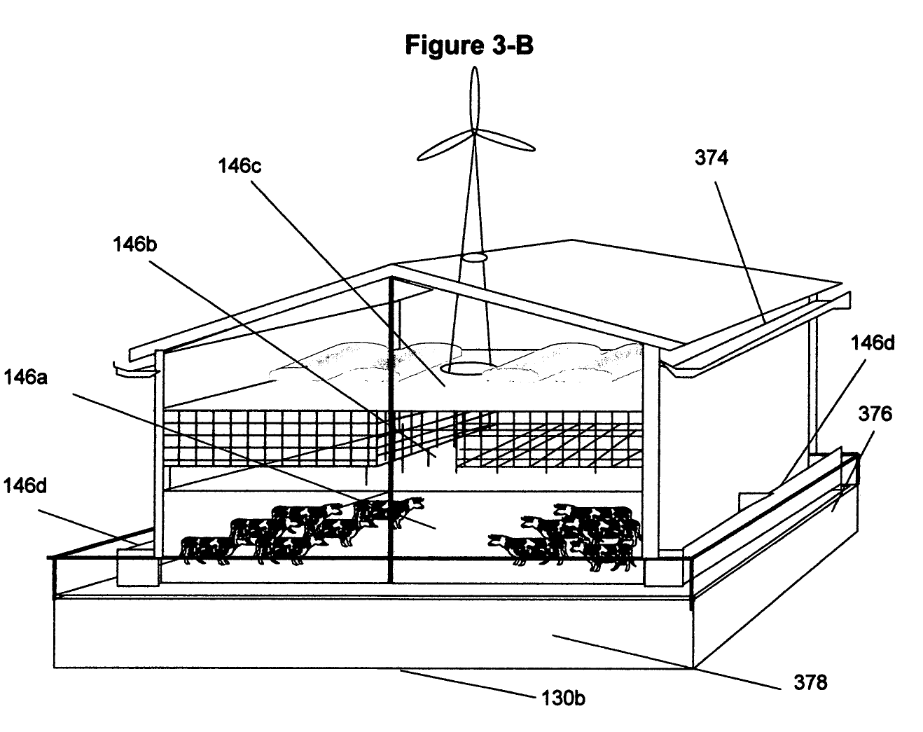

FIG. 3 shows a side view of an offshore municipal waste treatment facility. FIG. 3-A is a perspective view of the vermi-composting barge while FIG. 3-B is a perspective view of the food production barge. The waste depository barge that serves as platform for vermi-composting is the compost barge on the left 130a. The waste depository barge that serves as platform for food production is the food barge on the right 130b. The compost barge contains concrete vermi-composting bins 366 on the flat-top barge surface for vermi-composting of biodegradable waste. The roof deck is used as greenhouse for raising organically-grown food crops 146c. The roof is provided with solar panels 372 and water catchment device 374 to collect rainwater in built-in water reservoirs 376 on the left and right hulls of each barge.

The food barge 130b is lined parallel to the compost barge 130a to create a controlled sea condition between the two barges, thus allowing fish farming in floating cages 146g, seaweed farming 146e, and pearl farming 146f. The food barge 130b has cattle and dairy 146a on the barge surface, poultry 146b on the second floor, and raising of organic crops in a greenhouse 146c.

Vermi-composting of biodegradable waste in concrete bins 366 produces two valuable products: earthworm castings 140 and earthworm protein meal 144. The earthworm castings produced in the process serve as substrate for greenhouse organic crop raising 146c. Live earthworms serve as feed for freshwater fish raised in concrete tanks 146d. Earthworm protein meal, on the other hand, serves as feed ingredient for cattle/dairy 146a and poultry 146b.

Manure from cattle and poultry serve as activator 152 to hasten the composting and vermi-composting 366 of organic municipal waste. Part of the waste from livestock, to include dead animals and cuttings from the greenhouses shall serve as inputs to generate energy through biogas digesters 378 built into the barge interior. This will complement the energy derived from windmill 370 and solar panel 372 that go with each barge. Rainwater is collected by catchments on the roof of each barge 374 and deposited in water reservoirs 376 built into the left and right hull compartments of each barge. Biogas digesters 378 are built-in at the front and rear hull compartments of each barge.

Freshwater fish in 146d, in turn, serve as feed for saltwater fish in floating fish cages 146g, supplemented by earthworms produced from vermi-composting 366. In addition to floating fish cages for saltwater fish farming, seaweed farming 146e and pearl culture 146f are also made possible by the controlled sea condition created between the rows of compost barges 130a and food barges 130b. Personnel living space is provided in 368.

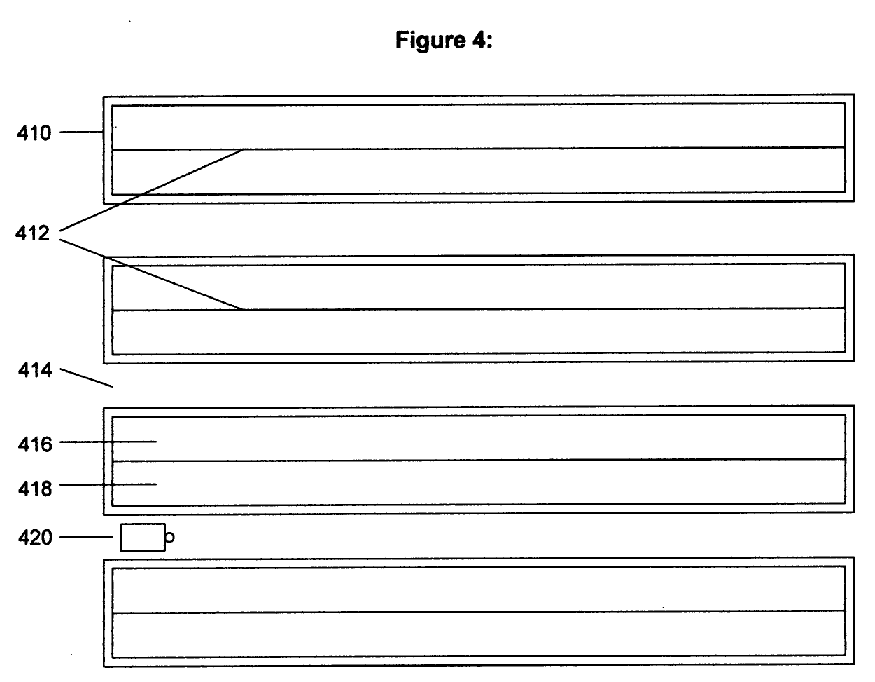

FIG. 4 shows the top view of vermi-composting bins laid on the flattop surface of the vermi-composting barge. The vermi-composting bins 410 are constructed preferably of concrete 0.6 meters high and 3 meters wide. A 1-cm wire mesh is placed as divider 412 with the same height as the bin to divide each bin into two sections: a first section 416; and a second section 418. Alleys 414 about 2 meters wide are provided in between each vermi-composting bin.

The arriving biodegradable waste are piled 0.4-0.5 m high in the first section 416 of the bin 410 and allowed to decompose. Composting of the biodegradable portion of the municipal waste is hastened by seeding with enzymes or activators and/or mixing with dried chicken dung or cow manure. The mixed materials are kept moist and aerated daily using a small tractor 420 with appropriate attachments for aerating the compost piles. The tractor 420 is also provided with other attachments for watering the compost materials in the bins and for loading and unloading materials.

Temperature in the compost piles will increase during the decomposition process which will take about 15 days or more, depending on the sizes in which the materials have been shredded. The smaller the sizes of the grinded or shredded materials, the faster will be the decomposition process. When the temperature in the compost pile has gone down to normal, the composted materials are then ready for earthworm seeding.

One kilogram of earthworms per square meter of bin area will consume the composted waste materials in 45 to 60 days. Initially, the seeding rate may be less than this in order to save on cost, since the earthworms multiply and increase in weight very rapidly. They can double in weight in about 60 days. The preferred earthworm species for vermi-composting of municipal waste is Eudrilus eugenie, but other species like Eisenia foetida and Lumbricus rubellis may also be used.

As the waste stream continues, the incoming biodegradable waste is subjected to composting in the second section 418 of the bins following the same procedure as was done on the first section 416. The earthworms in the first section 416 will automatically transfer to the newly composted biodegradable waste in the second section 418 after they have consumed the waste in the first section and converted them into earthworm castings. The castings in the first section are then harvested and replaced with new arrivals of biodegradable wastes for a repeat of the same cycle.

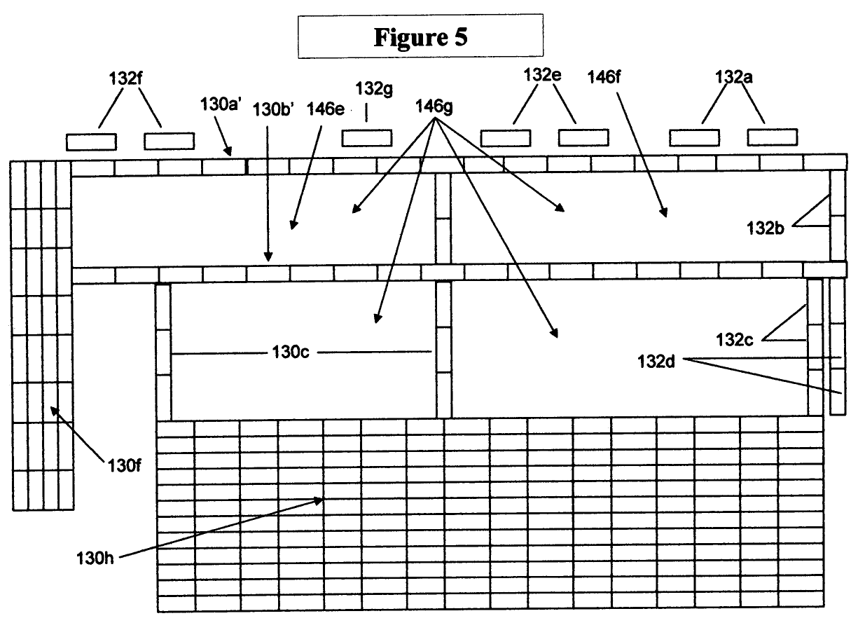

FIG. 5 shows a schematic diagram of the offshore municipal waste treatment facility. Shuttle barges containing biodegradable wastes in transfer bins unload at the landing area 130f. The biodegradable waste materials are then composted and fed to earthworms on compost barges. Compost barges aligned end-to-end serve as the outer breakwater 130a′ while food barges arranged likewise serve as the inner breakwater 130b′, thus creating a double breakwater system for added safety. Barges with hazardous waste 130c are positioned in the interior of the complex for greater protection from the elements. The arrangement also creates controlled sea conditions to allow floating fish cages 146g, seaweed farming 146e, and pearl culture 146f. A desalination plant 132a is installed to provide the water supply complemented by rainwater catchments. Power barges 132b installed with solar panels, windmills, biogas digesters, and equipment for tapping both tide and wave energy will ensure sustainable power supply for the offshore complex. Dedicated barges serving as water reservoir 132c and oil depot 132d shall form part of the offshore complex. There are also barges dedicated for collection and treatment of waste water 132e. Barges constructed and designed for personnel living quarters 132f are also provided. A barge dedicated for livestock feed mill processing 132g will supply the feed requirements for marine and livestock production. Excess depository barges 130g resulting in continued waste generation from cities and municipalities become building blocks to create an ever-expanding floating real estate 130h.

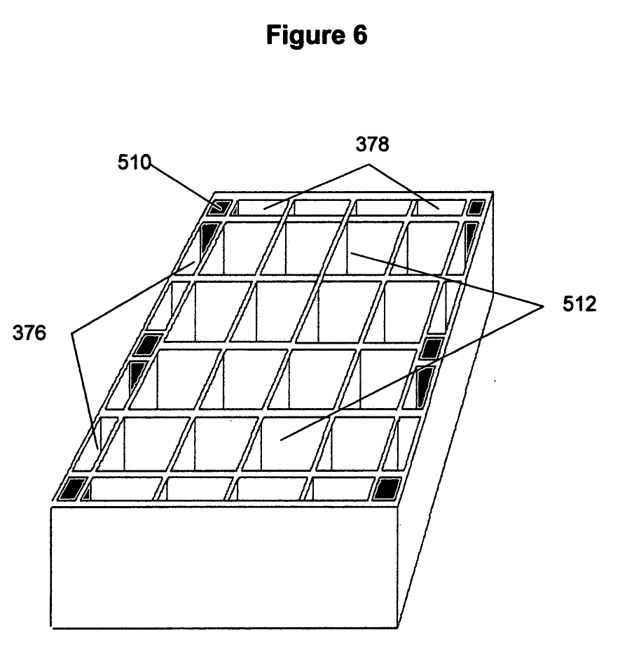

FIG. 6 shows a perspective view of an uncovered ferro-cement barge. The front and rear hulls are utilized as biogas digesters 378. The left and right hulls are utilized as water reservoir 376 for each barge. The barge is divided into segmented compartments 512. The barge has major posts 510 for strength and connections. The number of barge post may increase as the barge length is increased.

### DETAILS OF THE OPERATION

The process starts in a waste segregation facility (See FIGS. 1 and 2). Urban waste 110 comprising of mixed municipal waste 111, special waste 128 (such as construction and demolition debris, white goods like old refrigerators and freezers, bulky furniture, tires and the like), and some forms of hazardous waste 126 are separately fed into the system. As the waste arrive, the corresponding tipping fee 123 is collected to defray operational expenses. Municipal waste collected by garbage trucks are deposited into a series of tapering ramp with an impact breaker 112 leading to a conveyor belt 119 where sorters in masks (with filters) and protective clothing 118 positioned on both sides of the conveyor belt debag the waste 114 and using various tools segregate 116 the non-recyclable materials 124 from the biodegradable 120. Recyclable items 122 are separated to be sold to recycling firms.

Special waste 128 such as construction and demolition debris, white goods (refrigerator, air conditioners, freezers, etc.), bulky furniture (beds, sofas, etc.), tires, discarded vehicles, and the like are collected and treated separately. Freon and compressors are first removed from white goods before they are subjected to processing. Special waste materials are reduced by crushing, shredding or grinding 136 as the case may be. Ferrous and non-ferrous metals, plastics, glass and other recyclable materials 122 are recovered before the residual non-recyclable materials 124 are compacted and sealed in depository barges 130.

The segregated non-recyclable materials from the municipal waste 111 undergo reduction either by shredding, crushing, grinding and/or compacting 125, loaded in transfer bins and transferred using a tower crane 262 onto the depository barges 130, which are preferably flattop barges with segmented compartments and double hulls. The barges 130, after being sealed, are towed to an offshore municipal waste treatment facility 138. The flat-top surface of the ferro-cement barges serve as platform for concrete bins used for vermi-composting 366. The compost barges 130a and the food barges 130b are preferably connected end-to-end and parallel to each other so they can also serve as breakwater 130a′ and 130b′ for the entire offshore waste treatment facility 138. As more barges containing non-recyclable wastes are added, the excess barges 130g then form the beginning of a constantly expanding floating real estate 130h.

In an alternative embodiment, the amount of non-recyclable non-bio-degradable waste deposited on the barges may be significantly reduced by further separating out the non-recyclable non-biodegradable waste which are non-hazardous or non-toxic. These materials may be grinded and mixed with sand and cement to produce aggregates or hollow blocks. Separating these materials will free valuable space in the barges which can then be further utilized for other productive purposes.

Hazardous wastes 126 such as discarded electronic items will be collected separately, compacted or shredded when applicable 136, and deposited in separate, segmented, double-hulled barges 130c that will be sealed when filled. Other hazardous wastes will be treated in like manner except those in liquid form that need no compaction. Hospital wastes, on the other hand, can be treated using existing methods in the art and sealed in separate barges where methane-collecting devices are installed.

The segregated biodegradable materials 120, on the other hand, go through a grinder 121 and seeded with activators and deodorizers before being loaded on a shuttle barge 132 that will transport the biodegradable wastes to the offshore waste treatment facility 138. The biodegradable wastes are unloaded in a landing area 130f of the offshore facility.

The biodegradable waste is then brought to the vermi-composing platforms 366, piled in the first section of the concrete bin 416 and composted. There are many know methods of vermi-composting. In a preferred embodiment, the process is conducted in concrete bins 0.6 meters high and 3 meters wide. The biodegradable materials are first composted. The decomposition process is hastened by adding enzymes or activators such as dried cow dung or chicken manure. The resulting mixture is then kept moist and aerated daily using a small tractor with appropriate attachments for compost pile aeration, watering, and loading/unloading of material. After 15 days or more, the temperature in the compost piles will subside. The earthworms from the adjacent second section 418 will then automatically transfer to the newly composted pile in the first section 416 while the waste material in 418 that has been converted into earthworm casting and the earthworms contained in the piles shall be ready for harvest. Upon clearing the area of the second section 418, new incoming biodegradable waste may again be laid for composting to begin a new cycle.

Thus, the biodegradable waste is converted into earthworm castings 140, one of the finest forms of soil conditioner know to man. Part of the castings output can be packaged and sold as such, while the rest can be mixed with soil and rice hulls to serve as substrate for organic crop raising in greenhouses 146c on the top decks of the barges.

Another output of the vermi-composting process is earthworms. The preferred earthworm specie for vermi-composting is Eudrilus eugenie. They multiply very rapidly and consume all types of decomposed organic matter. Other alternative specie are Eisenia foetida and Lumbricus rubellis. These earthworms are hermaphrodites capable of reproducing by themselves, such that they can double in weight in about 60 days; The earthworms 144 can be dried and used as protein ingredient for fish and livestock feed 146 that will be produced in a feed mill barge 132g.

The segmented, double-hulled barges FIG. 6 used for the entire operation follow the principle of the bamboo. Even if holes are created through some segments of the bamboo, the bamboo will still remain afloat. With double-hulls, segmented compartments and flat bottoms, the floating stationary structures will be practically unsinkable like the bamboo. To protect the facility from natural calamities, it will be located in coves or harbors, making use of natural covers such as mountain ranges. Vertical construction atop the barges in the later stages can make use of pyramid structures as precaution against strong winds. The waste barges serving as outer breakwater 130a′ and food barges serving as inner double breakwater 130b′ serve as added protection for the offshore colony or community that will form within the offshore complex 138.

To complete the recycling process for the organic portion of the waste, food barges 130b are set up parallel to the compost barges 130a as shown in FIG. 3. A food production barge consists of a sealed barge containing non-recyclables with one or more floors added on top. The added floors are for cattle/dairy 146a and/or poultry 146b; while the roof deck is used as a greenhouse for organic crop production 146c using a mixture of worm castings, soil and rice hulls as substrate. The food barge will also contain concrete tanks for fresh water fish 146d. In between the compost barges and food barges are fish pens/nets 146g for the production of salt water fish like groupers. The area between the barges enjoys the benefit of controlled sea conditions, i.e., calmer waters, and will also be used for seaweed production 146e and pearl farming 146f.

The earthworms from vermi-composting 144 serve as feed for freshwater fish 146d and as protein ingredient for livestock feed for cattle 146a and poultry 146b. The freshwater fish, in turn, will serve as feed for saltwater fish production in floating fish cages 146g. Worm castings 140 from vermi-composting are mixed with soil to serve as substrate for organic farming in greenhouses 146c atop the food barges 130b. Manure from the feedlots and poultry 148, and garden wastes from organic farming 150 serve as power source through biogas digesters 378 and later on as additional substrate for vermi-composting in 366. Livestock casualties in the food barges also go to biogas digesters. A portion of the manure from the food barges will be used as activators 152 to hasten decomposition of the biodegradable portion of the municipal wastes before they are subjected to earthworm consumption or vermi-composting. Thus, the recycling cycle turns full circle resulting in “zero” wastes with no attendant pollution as in current methods of waste disposal like incinerators and sanitary landfills.

This whole waste recycling process can be kept odorless. Treatment with zeolite and lime, daily aeration of the compost piles, use of biogas digesters, and earthworm activity in vermi-composting all have the effect of removing any foul odor coming from organic wastes.

As more and more ferro-cement barges are filled up by non-recyclable and non-biodegradable wastes, the vermi-composting area that also serve as breakwater will keep on increasing in area and length. A period will later on be reached when there will be more than enough area to recycle the biodegradable wastes in a given city or locality. As more barges are added as a result of continued generation of wastes from urban centers, a never-ending, ever-expanding floating real estate will sprout literally from the wastes

Thus, the method of treating municipal waste as described above is one option for solving a previously insoluble environmental problem of where to dispose the wastes, as exemplified by New York City which recently decided to close the largest landfill site in the world but without any immediate viable options for dumping its waste. The reader can also see that the method addresses a long-felt public need of disposing municipal wastes without the attendant dangers from dioxins, furans, heavy metals, toxic ashes, explosive gases and leachates emanating from current methods of incineration and landfill. As added benefits, a new and unique way of producing food offshore can sprout literally from wastes, with an end result of producing a never-ending, ever expanding, valuable, movable real estate. The latter is like a blank sheet of canvass where modern cities of the future can be drawn. One can see that food, water, and alternative sources of energy can be made available and abundant in a sustainable manner in the offshore environment as described. Thus, this method of disposing and recycling municipal waste may one day contribute to man's colonization of the oceans, which comprise two-thirds of planet earth. Lastly, the jobs that can be generated by this unique process, if adapted by major cities of the world, are simply unimaginable.

1. A method of treating and disposing of municipal solid waste comprising the steps of:
segregating said municipal solid waste into biodegradable, recyclable, and non-recyclable waste;
sealing said non-recyclable materials segregated from said mixed municipal solid waste within a plurality of floating vessels; and
treating said biodegradable waste segregated from said mixed municipal solid waste on top of said plurality of floating vessels using a combination of vermi-composting and food production.

2. The method of treating and disposing municipal solid waste according to claim 1, wherein said vermi-composting occurs on a first one of said plurality of floating vessels and said food production occurs on at least a second one of said plurality of floating vessels.

3. The method of treating and disposing municipal solid waste according to claim 1, wherein worm castings produced from said vermi-composting are used as soil amendment.

4. The method of treating and disposing municipal solid waste according to claim 1, wherein worm castings produced from said vermi-composting are used as organic fertilizer.

5. The method of treating and disposing municipal solid waste according to claim 1, wherein said plurality of floating vessels are rust-proof.

6. The method of treating municipal solid waste according to claim 1, wherein said floating vessel is a barge made of laminated cementitious composite materials.

7. The method of treating municipal solid waste according to claim 6, wherein said laminated cementitious composite material is ferro-element.

8. The method of treating municipal solid waste according to claim 1, wherein said floating vessels have flat tops.

9. The method of treating municipal solid wastes according to claim 1, further comprising compacting said non-recyclable materials prior to sealing said non-recyclable materials in said plurality of floating vessels.

10. The method of treating municipal solid wastes according to claim 1, wherein said segregation of waste is conducted on either an inland or offshore facility.

11. The method of treating municipal solid wastes according to claim 1, further comprising converting said non-recyclable materials into construction materials by grinding and mixing said non-recyclable materials with sand and cement to form hollow blocks, aggregates, or other construction materials.

12. The method of treating biodegradable wastes according to claim 1, wherein vermi-composting is conducted on the flat-top surface of said floating vessels.

13. The method of food production according to claim 2, wherein food production is defined by livestock, marine life, and crop raising.

14. The method of recycling biodegradable wastes according to claim 1, further comprising offshore food production.

15. A waste recycling and food production complex for the treatment of municipal solid waste, comprising:
a waste segregation facility wherein municipal solid wastes are segregated into recyclables, non-recyclables, and biodegradable materials;
a plurality of flat-top floating vessels wherein said non-recyclable waste segregated at said waste segregation facility are deposited and sealed,
wherein at least one of said flat-top floating vessels is used for vermi-composting of said biodegradable waste materials, and
wherein another one of said plurality of said flat-top floating vessels is used to raise crops, livestock, or marine life.

16. The offshore complex according to claim 15, wherein said floating vessels are ferro-cement barges aligned end-to-end.

17. The offshore complex according to claim 15, wherein said plurality of floating vessels are barges made of metal or laminated cementitious composite materials.

18. The offshore complex according to claim 15, wherein dedicated power barges with windmills, biogas, solar, wave, and tide energy equipment are means for supplying the power requirements for said offshore complex.

19. The offshore complex according to claim 15 wherein dedicated desalination barges and built-in rainwater catchments in each barge are means for supplying the water requirements for said offshore complex.

20. An offshore complex according to claim 15 wherein a constantly expanding and movable real estate is formed by the continuous arrival of said depository barges containing said non-recyclable waste materials.
